(19) United States
(12) Patent Application Publication
(10) Pub. No.: US 2025/0220417 A1
(43) Pub. Date: Jul. 3, 2025

(54) OPPORTUNISTIC KEY CACHING IN SUITE-B-192

(71) Applicant: Cisco Technology, Inc., San Jose, CA (US)

(72) Inventors: Jegan Manoharan, Bangalore (IN); Sachin D. Wakudkar, St-Sulpice (CH); Stephen M. Orr, Wallkill, NY (US)

(73) Assignee: Cisco Technology, Inc., San Jose, CA (US)

(21) Appl. No.: 18/786,297

(22) Filed: Jul. 26, 2024

(30) Foreign Application Priority Data
Dec. 29, 2023 (IN) 202341089900

(51) Int. Cl. H04W 12/043; H04W 12/041; H04W 12/06

(52) U.S. Cl. CPC H04W 12/043; H04W 12/041; H04W 12/06

(57) ABSTRACT

Opportunistic Key Caching (OKC) in Suite-B-192 Authentication and Key Management (AKM) may be provided. OKC in Suite-B-192 AKM can comprise performing an association process with a Station (STA). An initial Key Confirmation Key (KCK) can be received, and a Pairwise Master Key (PMK) Identifier (PMKID) is determined based on the initial KCK. A four-way handshake is performed to derive one or more keys using the PMKID.

### RELATED APPLICATION

Under provisions of 35 U.S.C. § 119 (e), Applicant claims the benefit of and priority to Indian Provisional Application No. 202341089900, filed Dec. 29, 2023, the disclosure of which is incorporated herein by reference in its entirety.

### TECHNICAL FIELD

The present disclosure relates generally to providing Opportunistic Key Caching (OKC) in Suite-B-192 Authentication and Key Management (AKM).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Opportunistic Key Caching (OKC) in Suite-B-192 Authentication and Key Management (AKM) in accordance with aspects of the present disclosure.

FIG. 2 is a block diagram of a security association element in accordance with aspects of the present disclosure.

FIG. 3 is a signal process for OKC in Suite-B-192 AKM in accordance with aspects of the present disclosure.

FIG. 4 is a flow chart of a method for OKC in Suite-B-192 AKM in accordance with aspects of the present disclosure.

FIG. 5 is a block diagram of a computing device in accordance with aspects of the present disclosure.

FIG. 6 is a block diagram of a wireless device in accordance with aspects of the present disclosure.

### DETAILED DESCRIPTION

### Overview

Opportunistic Key Caching (OKC) in Suite-B-192 Authentication and Key Management (AKM) may be provided. OKC in Suite-B-192 AKM can comprise performing an association process with a Station (STA). An initial Key Confirmation Key (KCK) can be received, and a Pairwise Master Key (PMK) Identifier (PMKID) is determined based on the initial KCK. A four-way handshake is performed to derive one or more keys using the PMKID.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Pairwise Master Key (PMK) caching in a wireless deployment enables skipping the authentication of the wireless Stations (STA) and enables faster transition between Basic Service Sets (BSSs) or during re-association to the same Basic Service Set (BSS). Opportunistic Key Caching (OKC) is a method of PMK caching that can be utilized in a network. The OKC technique allows wireless clients (i.e., STAs) and the WLAN infrastructure to cache only one PMK for client association with a Wireless Local Area Network (WLAN), even when roaming between multiple APs because the PMK that is used for the Wi-Fi Protected Access Second Generation (WPA2) four-way handshake is shared. The shared PMK is required to generate new encryption keys every time a client reassociates with APs. For APs to share the original PMK from a client session, the APs may all be associated with a centralized device that caches and distributes the original PMK to all the APs.

When using OKC, a client's initial association to an AP is a regular first-time authentication to the corresponding WLAN, and the client and networks devices must complete the entire authentication process for the authentication server and the four-way handshake for key generation. For example, the process described in the Institute of Electrical and Electronics Engineers (IEEE) 802.1X Extensible Authentication Protocol standards and amendments may be required during first-time authentication of a device. The client may not be able to send data before performing the first-time authentication requirements. Thus, OKC is an optimization method for roaming to derive new encryption keys for an AP a client roams or otherwise associates to without having to perform a complete authentication process.

WPA2 supports OKC with PMK as a key to derive the PMK Identifier (PMKID) of a client. However, with the introduction of the Wi-Fi Protected Access Third Generation (WPA3) and the Suite-B-192 security suite, the PMKID derivation method has changed from using PMK to using the Key Confirmation Key (KCK) KCK derived during the initial four-way exchange for a client. The switch to using KCK leads to the usual method for implementing OKC to no longer function, and there has been no clear method introduced to implement OKC in the Suite-B-192 Authentication and Key Management (AKM).

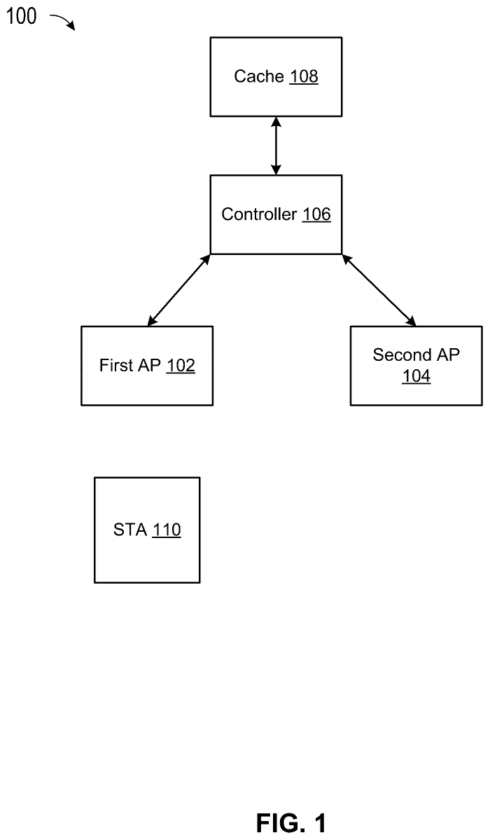

FIG. 1 is a block diagram of an operating environment 100 for Opportunistic Key Caching (OKC) in Suite-B-192 Authentication and Key Management (AKM). The operating environment 100 includes a first AP 102, a second AP 104, a controller 106, a cache 108, and a STA 110. The first AP 102 and the second AP 104 can enable clients to connect to the network and communicate with other devices connected to the network. The controller 106 may manage the first AP 102, the second AP 104, and/or other devices of the network. The controller 106 for example can manage the operation of the first AP 102 and the second AP 104, manage the traffic of the first AP 102 and the second AP 104, and so on. The cache 108 can store keys and other information for client authentication, such as client IDs, KCKs, Pairwise Transient Keys (PTKs) including the Transient Key (TK), KCK, and Key Encryption Key (KEK), PMKs, and/or the like. In certain embodiments, the cache 108 is part of a central server. In further embodiments, the cache 108 is a component of the controller 106 or some other device in the operating environment 100. The STA 110 can be any device that connects to the network to communicate with other devices on the network, such as a smart phone, a tablet, a personal computer, a server, and/or the like.

The devices in the operating environment 100 and/or other devices of the network the first AP 102, the second AP 104, the controller 106, and/or the cache 108 are a part of may be utilizing WPA3 Suite-B-192 AKM. So, to utilize OKC when roaming to a new AP, the devices of the network must utilize the KCK to derive the PMKID. There may be a different number of devices in the operating environment 100 in other embodiments, such as more APs, more controllers, more caches, more STAs, and/or the like.

When the STA 110 first associates with an AP, such as the first AP 102 for example, the STA 110, the AP, and/or other network devices perform a first-time authentication process (e.g., as described by IEEE 802.1X). During the first-time authentication process, the STA 110 and the AP being associated to (e.g., the first AP 102) derive the PMK and use the PMK to derive the initial PTK, including a TK, a KCK, and a KEK. The TK is the data encryption key used to encrypt data packets. The KCK is a confirmation key used to derive the Message Integrity Check (MIC) in a four-way exchange to ensure the integrity of the security association. The KEK is used to encrypt key-related data in a four-way exchange.

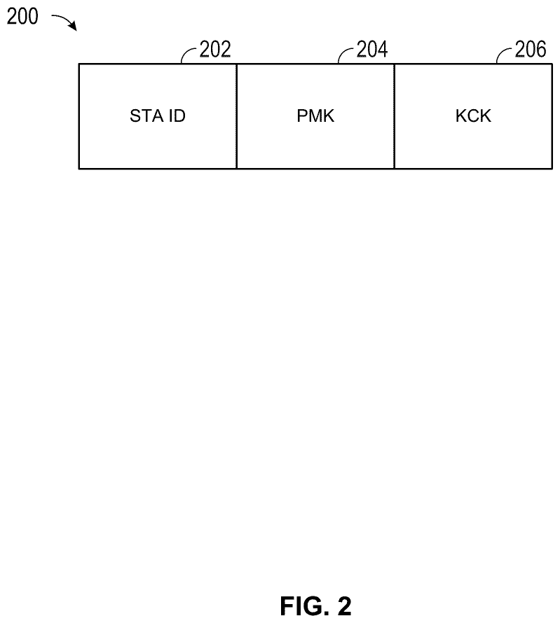

FIG. 2 is a block diagram of a security association element 200. After the first-time authentication process, the AP the STA 110 is associating to can send data for a security association element 200 to the controller 106 and/or the cache 108. For example, the first AP 102 may provide the data to the controller 106 or otherwise provide the information for storage in the cache 108. The security association element 200 includes a STA ID field 202, a PMK field 204, and a KCK field 206.

The STA ID field 202 can include data identifying the STA 110, such as the Media Access Control (MAC) address of the STA 110. The first AP 102 can provide the data identifying the STA 110 for storage in the STA ID field 202. PMK information, including the PMK, the lifetime of the PMK, the PMKID, and/or the like is derived during the first-time association and authentication process. The first AP 102 can send the PMK information to be stored in the PMK field 204. A PTK including a KCK is also derived during the first-time association process, and the first AP 102 can send the derived KCK to be stored in the KCK field 206. Thus, the security association element 200 includes data identifying the associated STA (e.g., the STA 110) in the STA ID field 202, PMK information in the PMK field 204, and the initial KCK in the KCK field 206.

The cache 108 can store security association elements 200 for client devices including the STA 110. Thus, the first AP 102, the second AP 104, the controller 106, and/or other devices of the network can access the security association elements 200 stored in the cache 108 to perform OKC when a client device roams to a new AP. The storage and access of the KCK and other information of the security association element 200 may be similar to the storage and distribution of the PMK Security Association (PMKSA) performed for WPA2. The security association element 200 can include more or fewer fields in further embodiments.

Referring back to FIG. 1, after the first-time association and authentication process, the STA 110 is associated to the initial AP, such as the first AP 102. The STA 110 can then communicate with other devices in the network. When the STA 110 roams to a new AP, such as the second AP 104, the STA 110 and the second AP 104 can utilize OKC to skip authentication process steps by using the KCK derived during the first-time association and authentication process. When the STA 110 associates to a new AP, the cache 108 is used to skip the authentication steps (e.g., as described by IEEE 802.1X) and derive a new PTK for the new AP. The PMKID is a hash that is derived from PMK to identify the PMK in the PMK cache in the WPA2 security method. However, in the Suite-B-192 security method, instead of the PMK, the KCK derived from the initial association is used to derive the PMKID. Because the KCK derived from the initial four-way handshake is stored in the KCK field 206 and made available by the cache 108, the new AP can use the initial KCK to derive the PMKID for the new association.

The second AP 104 can access the KCK derived during the first-time association process to perform OKC. For example, the second AP 104 may request (e.g., from the controller 106) data from the security association element 200 of the STA 110 stored by the cache 108 to determine the initial KCK derived in the first-time association and authentication process. The second AP 104 can then use the initial KCK and other information in the STA 110 security association element 200 to derive the PMKID for the association of the STA 110 to the second AP 104. In embodiments, the PMKID is derived by applying a hash function to the concatenation of the initial KCK, the address of authenticator (i.e., the new AP address), and address of supplicant (i.e., the STA address). Thus, PMKID=Hash (initial KCK|Address Authenticator|Address Supplicant). For example, when the STA 110 roams from the first AP 102, the second AP 104, the PMKID would be derived by applying a hash function to the concatenation of the initial KCK (e.g., as stored in the KCK field 206 of the STA 110 security association element 200), the MAC address of the second AP 104, and the MAC address of the STA 110 (e.g., as stored in the STA ID field 202 of the STA 110 security association element 200). The second AP 104 can therefore derive the PMKID for the STA 110 association to the second AP 104 by applying the hash function to the concatenation of the initial KCK of the STA 110, the second AP 104 MAC address, and the STA 110 MAC address.

Once the second AP 104 derives the PMKID for the STA 110 association to the second AP 104, the second AP 104 can derive a new PTK for the STA 110 and complete the association. For example, the second AP 104 can perform another four-way handshake using the PMKID, the PTK, and/or the like to complete the STA 110 association process to the second AP 104.

When a device, such as the STA 110, performs the first-time association and authentication process to connect to the network utilizing Suite-B-192 security methods, the device can store the initial KCK derived for use when associating to a new AP. The STA 110 can store the initial KCK when associating to a new BSS for example. Thus, the STA 110 can provide the initial KCK when roaming to a new AP instead of the cache 108 in some example implementations.

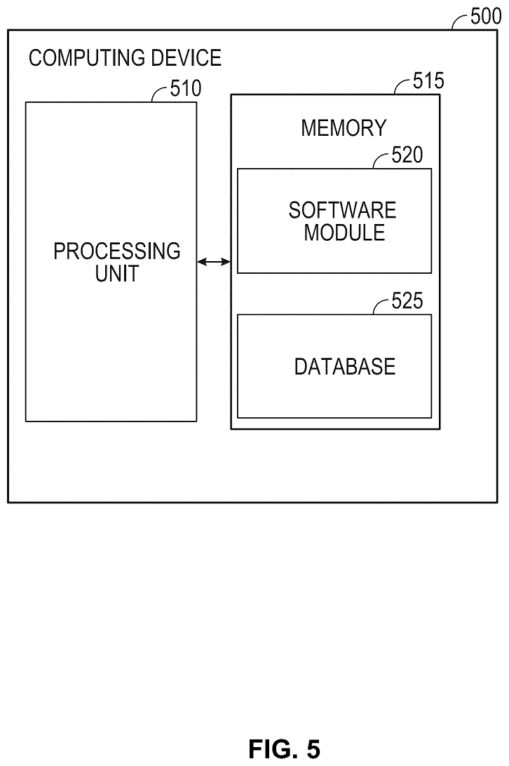

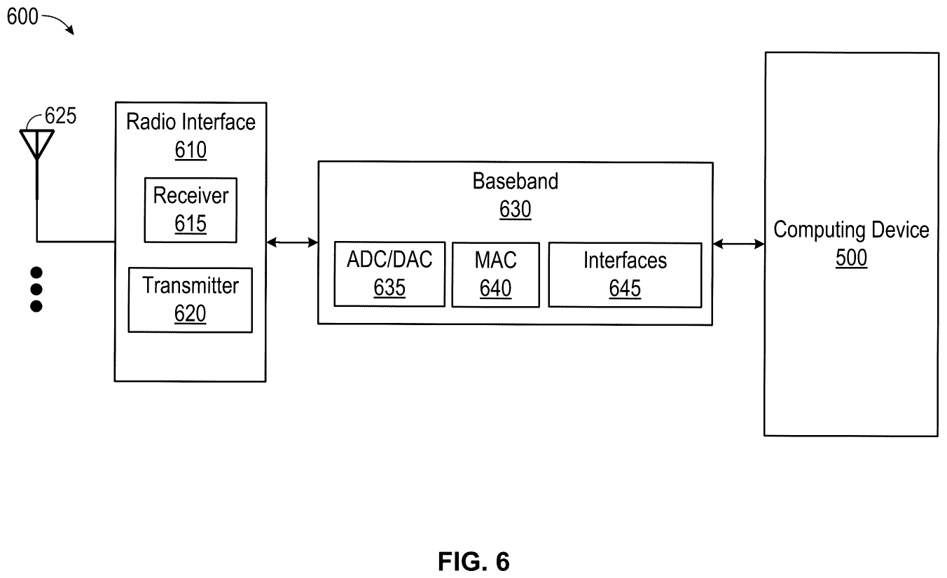

The elements described above of the operating environment 100 (e.g., the first AP 102, the second AP 104, the controller 106, the cache 108, the STA 110, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

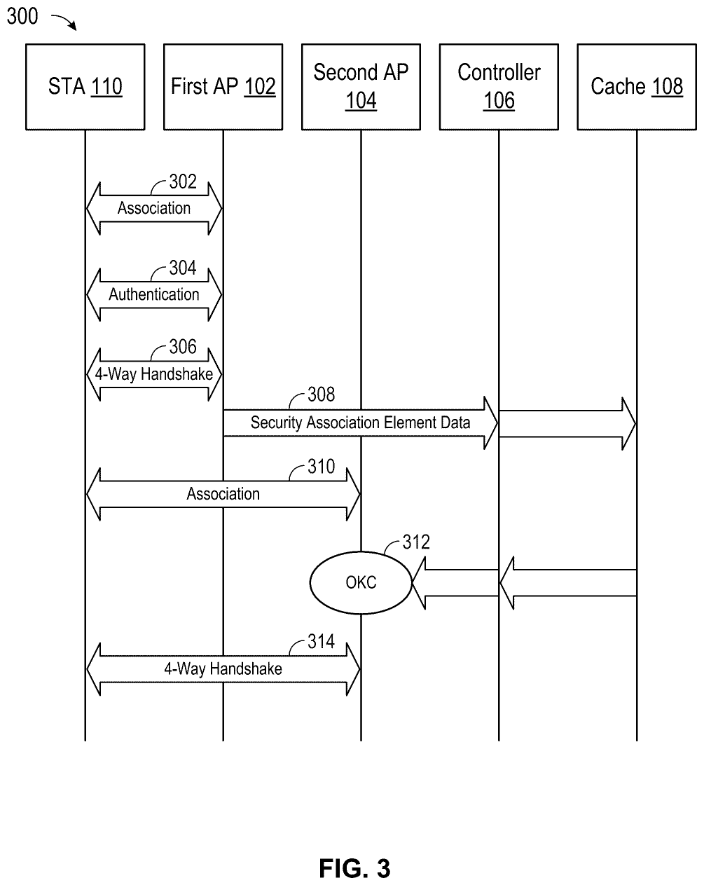

FIG. 3 is a signal process 300 for OKC in Suite-B-192 AKM. The signal process 300 can begin with an initial association process 302 of the STA 110 to the first AP 102. The initial association process 302 can include association steps for a client device to associate to an AP, such as the first AP 102 sending beacons, the STA 110 sending a probe request, the first AP 102 sending a probe response, the STA 110 sending an association request, and the first AP 102 sending an association response, and/or the like.

The STA 110 and the first AP 102 can then perform a first-time authentication process 304. The first-time authentication process 304 can include the process described in the Institute of Electrical and Electronics Engineers (IEEE) 802.1X Extensible Authentication Protocol standards and amendments. The STA 110 and the first AP 102 can then generate keys with a four-way handshake 306, for example for encrypting traffic between the STA 110 and the first AP 102. The STA 110 may finish associating and authenticating and may communicate with devices of the network via the first AP 102 after the four-way handshake 306.

The first AP 102 can send security association element data to the controller 106 and/or the cache 108 via signal 308. The security association element data can include STA ID information, PMK information, the initial KCK of the STA 110, and/or the like. When the first AP 102 sends the security association element data to the controller 106, the controller 106 can forward the security association element data to the cache 108.

When the STA 110 determines to roam to a new AP, the second AP 104 in this example, the STA 110 can perform an association process 310 with the new AP. The STA 110 and the second AP 104 can perform association steps for a client device to associate to an AP, such as the steps described above with respect to the initial association process 302.

The second AP 104 can then perform an OKC process 312. The OKC process 312 can include requesting and receiving security association element data from the security association element 200 the cache 108 stores in response to receiving the security association element data via the signal 308. The OKC process 312 can also include determining the PMKID by applying a hash function to the concatenation of the initial KCK of the STA 110, the second AP 104 MAC address, and the STA 110 MAC address. The second AP 104 can also derive a new PTK. The STA 110 and the second AP 104 can complete another four-way handshake process 314 to generate keys, for example for encrypting traffic between the STA 110 and the second AP 104. Once the four-way handshake process 316 is complete, the STA 110 can communicate with devices connected to the network via the second AP 104. Because of the OKC process 312, the STA 110 and the second AP 104 do not have to perform an authentication process, such as the first-time authentication process 304, resulting in the STA 110 roaming to the second AP 104 faster than if an authentication process was performed.

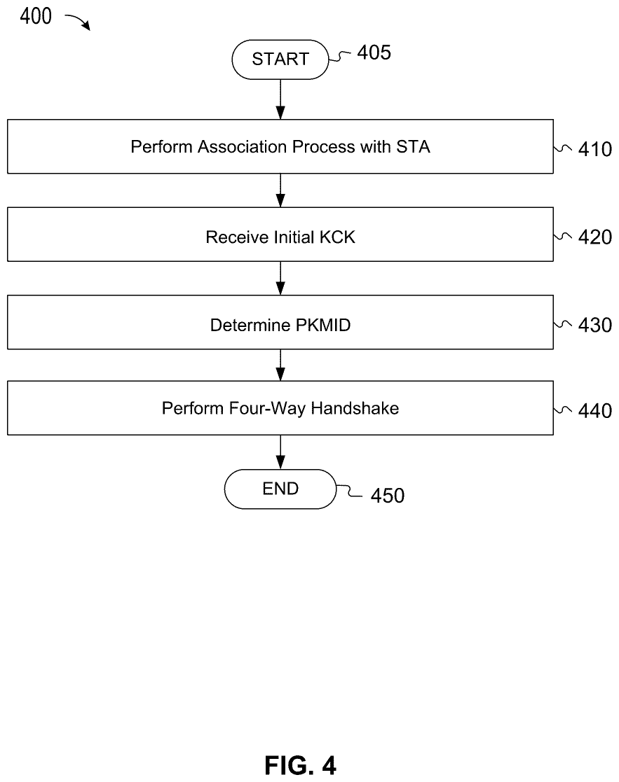

FIG. 4 is a flow chart of a method 400 for OKC in Suite-B-192 AKM. The method 400 can begin at starting block 405 and proceed to operation 410. In operation 410, an association process is performed with a STA. For example, the second AP 104 performs the association process 310 with the STA 110. The association process can be initiated by the STA 110 determining to roam to the second AP 104.

In operation 420, an initial KCK is received. For example, the second AP 104 may perform OKC, including requesting and receiving the initial KCK from the cache 108. The initial KCK can be derived during an initial association and authentication process of the STA with an AP, such as the initial association process 302, the first-time authentication process 304, and the four-way handshake 306 with the first AP 102. The first AP 102 can send the initial KCK to the cache 108 after the initial association and authentication process (e.g., via the controller 106). The cache 108 can store the initial KCK in a security association element 200 associated with the STA 110. The STA 110 can also store the initial KCK, and the STA 110 can provide the initial KCK instead of the cache 108 in some example implementations.

In operation 430, a PMKID is determined based on the initial KCK. For example, the second AP 104 determines the PMKID based on the initial KCK. Determining the PMKID can include applying a hash function to a concatenation of the initial KCK, an address of authenticator (e.g., the second AP 104), and an address of the STA 110.

In operation 440, a four-way handshake is performed to derive one or more keys using the PMKID. For example, the second AP 104 uses the PMKID to derive a PMK based on the PMKID, uses the PMK to derive a new PTK for the STA 110, and performs the four-way handshake process 314 using the new PTK. The method 400 can conclude at ending block 450.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for OKC in Suite-B-129 AKM with respect to FIG. 1, FIG. 2, FIG. 3, and FIG. 4. Computing device 500, for example, may provide an operating environment for the first AP 102, the second AP 104, the controller 106, the cache 108, the STA 110, and the like. The first AP 102, the second AP 104, the controller 106, the cache 108, the STA 110, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

FIG. 6 illustrates an implementation of a communications device 600 that may implement one or more of the first AP 102, the second AP 104, the controller 106, the cache 108, the STA 110, etc., of FIGS. 1-4. In various implementations, the communications device 600 may comprise a logic circuit. The logic circuit may include physical circuits to perform operations described for one or more of the first AP 102, the second AP 104, the controller 106, the cache 108, the STA 110, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for the first AP 102, the second AP 104, the controller 106, the cache 108, the STA 110, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHYsical layer (PHY) processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
performing an association process with a Station (STA);
receiving an initial Key Confirmation Key (KCK);
determining a Pairwise Master Key (PMK) Identifier (PMKID) based on the initial KCK; and
performing a four-way handshake to derive one or more keys using the PMKID.

2. The method of claim 1, wherein the initial KCK is derived during an initial association and authentication process of the STA with an Access Point (AP).

3. The method of claim 2, wherein receiving the initial KCK comprises receiving the initial KCK from a cache, wherein the AP sends the initial KCK to the cache after the initial association and authentication process.

4. The method of claim 1, wherein determining the PMKID based on the initial KCK comprises applying a hash function to a concatenation of the initial KCK, an address of authenticator, and an address of the STA.

5. The method of claim 1, wherein the STA stores the initial KCK, and wherein receiving the initial KCK comprises receiving the initial KCK from the STA.

6. The method of claim 1, wherein receiving the initial KCK comprises receiving the initial KCK from a security association element stored by a cache, wherein the security association element comprises an STA ID field and a KCK field.

7. The method of claim 1, further comprising:
deriving a PMK based on the PMKID; and
deriving a new Pairwise Transient Key (PTK) for the STA based on the PMK, wherein performing the four-way handshake to derive the one or more keys comprises using the new PTK.

8. A system comprising:
a memory storage; and
a processing unit coupled to the memory storage, wherein the processing unit is operative to:
perform an association process with a Station (STA);
receive an initial Key Confirmation Key (KCK);
determine a Pairwise Master Key (PMK) Identifier (PMKID) based on the initial KCK; and
perform a four-way handshake to derive one or more keys using the PMKID.

9. The system of claim 8, wherein the initial KCK is derived during an initial association and authentication process of the STA with an Access Point (AP).

10. The system of claim 9, wherein to receive the initial KCK comprises to receive the initial KCK from a cache, wherein the AP sends the initial KCK to the cache after the initial association and authentication process.

11. The system of claim 8, wherein to determine the PMKID based on the initial KCK comprises to apply a hash function to a concatenation of the initial KCK, an address of authenticator, and an address of the STA.

12. The system of claim 8, wherein the STA stores the initial KCK, and wherein receiving the initial KCK comprises receiving the initial KCK from the STA.

13. The system of claim 8, wherein to receive the initial KCK comprises to receive the initial KCK from a security association element stored by a cache, wherein the security association element comprises an STA ID field and a KCK field.

14. The system of claim 8, the processing unit being further operative to:
derive a PMK based on the PMKID; and
derive a new Pairwise Transient Key (PTK) for the STA based on the PMK, wherein to perform the four-way handshake to derive the one or more keys comprises to use the new PTK.

15. A non-transitory computer-readable medium that stores a set of instructions which when executed perform a method executed by the set of instructions comprising:
performing an association process with a Station (STA);
receiving an initial Key Confirmation Key (KCK);
determining a Pairwise Master Key (PMK) Identifier (PMKID) based on the initial KCK; and
performing a four-way handshake to derive one or more keys using the PMKID.

16. The non-transitory computer-readable medium of claim 15, wherein the initial KCK is derived during an initial association and authentication process of the STA with an Access Point (AP).

17. The non-transitory computer-readable medium of claim 16, wherein receiving the initial KCK comprises receiving the initial KCK from a cache, wherein the AP sends the initial KCK to the cache after the initial association and authentication process.

18. The non-transitory computer-readable medium of claim 15, wherein determining the PMKID based on the initial KCK comprises applying a hash function to a concatenation of the initial KCK, an address of authenticator, and an address of the STA.

19. The non-transitory computer-readable medium of claim 15, wherein receiving the initial KCK comprises receiving the initial KCK from a security association element stored by a cache, wherein the security association element comprises an STA ID field and a KCK field.

20. The non-transitory computer-readable medium of claim 15, the method executed by the set of instructions further comprising:
deriving a PMK based on the PMKID; and
deriving a new Pairwise Transient Key (PTK) for the STA based on the PMK, wherein performing the four-way handshake to derive the one or more keys comprises using the new PTK.
